(19) United States
(12) Patent Application Publication
(10) Pub. No.: US 2026/0211855 A1
(43) Pub. Date: Jul. 23, 2026

(54) DATA MIGRATION SUPPORT DEVICE AND DATA MIGRATION SUPPORT METHOD

(71) Applicant: Hitachi Vantara, Ltd., Yokohama-shi (JP)

(72) Inventors: Miho KOBAYASHI, Tokyo (JP); Tsukasa SHIBAYAMA, Tokyo (JP); Norio SHIMOZONO, Tokyo (JP); Yoshinori OHIRA, Tokyo (JP)

(73) Assignee: Hitachi Vantara, Ltd., Yokohama-shi (JP)

(21) Appl. No.: 19/333,020

(22) Filed: Sep. 18, 2025

(30) Foreign Application Priority Data
Jan. 6, 2025 (JP) 2025-001748

(51) Int. Cl. G06F 16/21

(52) U.S. Cl. CPC G06F 16/214

(57) ABSTRACT

The present invention enables decision of a data migration destination to be carried out easily and appropriately. A storage system which supports migration of migration target data in a computer system including a plurality of storage systems includes a storage unit and a CPU, and the storage unit stores configuration information including a type and a redundancy method of each of the plurality of storage systems, and the CPU is configured to receive designation of information that can identify a redundancy level of the migration target data and a type of a migration destination storage system, and to determine a storage system to which the migration target data is to be migrated, on the basis of the redundancy level of the migration target data and the type.

### BACKGROUND OF THE INVENTION

### 1. Field of the Invention

The present invention relates to a technique for supporting migration of data stored in a storage system to another storage system.

### 2. Description of the Related Art

In order to store data to be used for processing in an appropriate storage location depending on purposes, etc., the introduction of multi-cloud systems, which include different types of infrastructure such as an on-premise system, a private cloud, and a public cloud is becoming widespread. One of the benefits of multi-cloud systems is the flexibility to move data to an appropriate infrastructure.

For example, currently there are cases where mission-critical data is used in a cloud, and the need to migrate data from an on-premise system to a cloud is increasing. In addition, there are also cases where cloud data is required to be migrated to an on-premise system due to operational costs or performance issues, and there is also a need for data migration from a cloud to an on-premise system.

Further, high availability is required for data to be used in processing, and for example, JP 2024-095203-A discloses a highly available information processing system that can withstand failures at each site.

### SUMMARY OF THE INVENTION

For example, at a time of migrating data, it is difficult for a user who does not understand configurations and characteristics of an on-premise system, a private cloud, a public cloud, etc., to determine an appropriate migration destination for the data, and even for a user who understands the configurations and characteristics, determining the destination is time-consuming.

The present invention has been made in consideration of the above circumstances, and an object of the present invention is to provide a technique that can easily and appropriately determine a migration destination of data.

In order to achieve the above object, a data migration support device according to one aspect is a data migration support device that supports migration of migration target data in a computer system including a plurality of storage systems, the device including a storage unit, and a processor, in which the storage unit stores configuration information including a type and a redundancy method of each of the plurality of storage systems, and the processor receives designation of information that can identify a redundancy level of the migration target data and a type of a migration destination storage system, and determines a storage system to which the migration target data is to be migrated, on the basis of the redundancy level of the migration target data and the type.

According to the present invention, the migration destination of data can be determined easily and appropriately.

### BRIEF DESCRIPTION OF THE DRAWINGS

FIG. 1 is a diagram illustrating an overview of a computer system according to an embodiment;

FIG. 2 is a hardware configuration diagram of a computer system according to the embodiment;

FIG. 3 is a configuration diagram of a storage system management tool according to the embodiment;

FIG. 4 is a diagram illustrating a user operation screen according to the embodiment;

FIG. 5 is a flowchart of a VOL migration process according to the embodiment; and

FIG. 6 is a flowchart of a migration destination determining process according to the embodiment.

### DESCRIPTION OF THE PREFERRED EMBODIMENT

The embodiments will be described with reference to the drawings. Note that the embodiment described below does not limit the invention according to the claims, and not all of the elements and combinations thereof described in the embodiment are necessarily essential for the solution of the invention.

In the following description, the processing may be described with a “program” as the operating subject, but since the program is executed by a processor to perform a specified process while appropriately using at least one of a storage device and an interface, the processing subject may be the processor (or a computer or a computer system having a processor). The program may be installed in the computer from a program source. The program source may be a program distribution server or a computer-readable recording medium (e.g., a portable recording medium), for example. In the following description, two or more programs may be implemented as one program, or one program may be implemented as two or more programs. Further, at least a part of the processing implemented by executing a program may be performed by a hardware circuit (for example, an application specific integrated circuit (ASIC) or a field-programmable gate array (FPGA)).

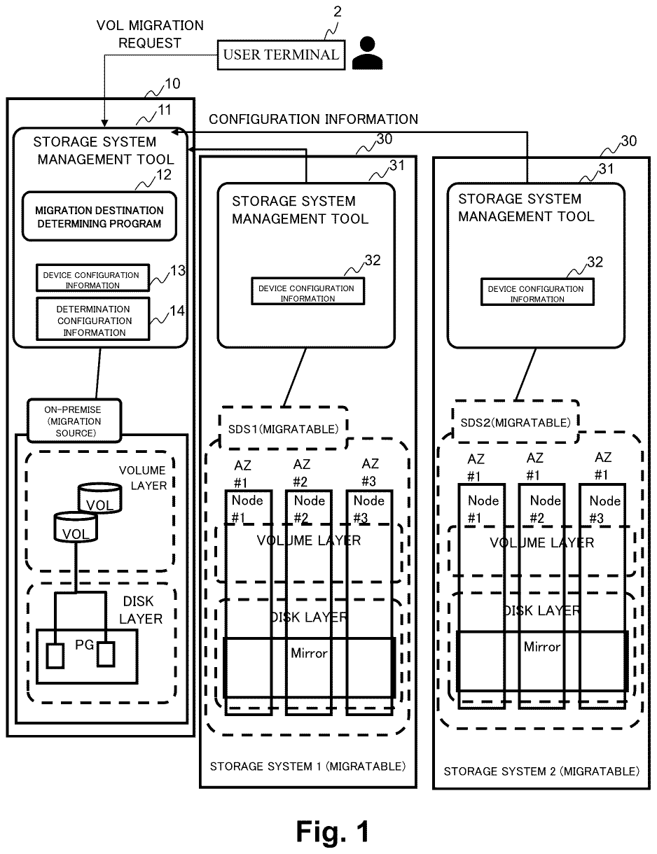

FIG. 1 is a diagram illustrating an overview of a computer system according to an embodiment.

A computer system 1 includes a user terminal 2 used by a user, a storage system 10 which is the source of migration and which stores a volume (VOL) that is an example of the migration target data, and a plurality of storage systems 30 to which the migration target data can be migrated.

The storage system 10 is an on-premise type storage system. The storage system 10 is an example of a data migration support device, and also functions as a storage system management tool 11.

The storage system management tool 11 includes a migration destination determining program 12, device configuration information 13, and determination information 14. The device configuration information 13 is information relating to the device configuration of the storage system 10. The determination information 14 is information for determining the migration destination.

The storage system 30 is a cloud-type storage system configured by a plurality of storage defined server (SDS) nodes, for example. The cloud types include types such as a public cloud and a private cloud, for example. A plurality of SDS nodes may be divided into one or more availability zones (AZ). The storage system 30 functions as a storage system management tool 31 and stores device configuration information 32 relating to the device configuration of the storage system 30.

The storage system management tool 11 checks the storage configuration of the storage system 10 that is a migration source and the redundancy status of the data to be migrated, and determines and selects, from among a plurality of storage systems to which data can be migrated, a storage system that has a data redundancy level equal to or higher than that of the migration source (in some cases, a specification equal to or higher than that of the migration source), thereby determining the location (node, etc.) where the data is to be stored, to migrate the data.

The migration destination determining program 12 collects configuration information of the storage system of the migration source and configuration information of storage systems which can be used for migration, and stores the pieces of configuration information as the determination information 14, thereby determining the storage system with the optimal configuration as the data migration destination and the node in which the data is to be stored. The migration destination determining program 12 determines a storage system having a redundancy level equal to or higher than the redundancy level of the data to be migrated as the migration destination storage system. In addition, when determining that a plurality of storage systems are possible migration destinations, the migration destination determining program 12 may determine the optimal storage system on the basis of priority items specified by the user (e.g., cost, performance, and reliability).

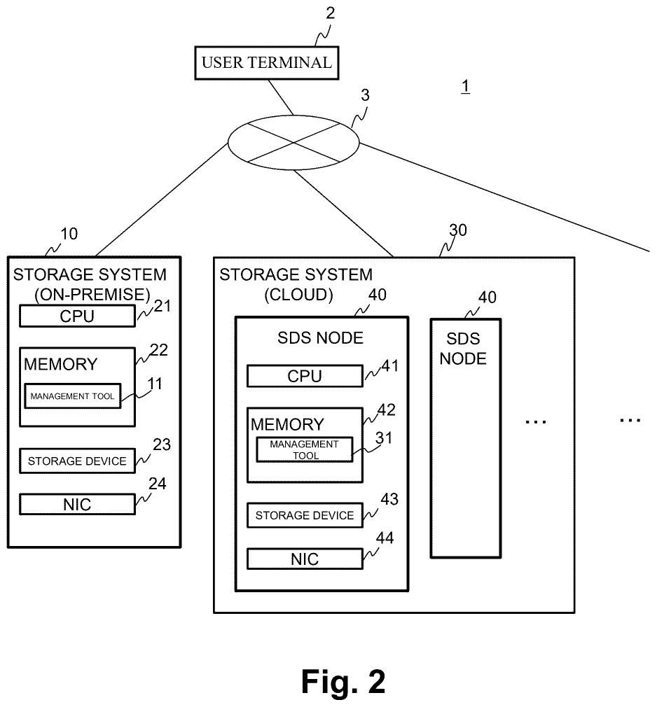

FIG. 2 is a diagram illustrating the hardware configuration of a computer system according to the embodiment.

The computer system 1 includes the user terminal 2, the storage system 10, and the plurality of storage systems 30. The user terminal 2, the storage system 10, and the storage system 30 are connected via a network 3.

The network 3 is a network such as a wired local area network (LAN), a wireless LAN, or a wide area network (WAN).

The user terminal 2 is constituted by a personal computer (PC), for example, and communicates with other devices (the storage system 10, the storage system 30, etc.) via the network 3 to execute display output of various types of information for the user, and accepts input of various types of instructions from the user.

The storage system 10 includes one or more computers such as general-purpose servers, for example. In the present embodiment, the storage system 10 is configured as an on-premise system. The storage system 10 includes a central processing unit (CPU) 21 as an example of a processor, a memory 22, a storage device 23, and a network interface card (NIC) 24.

The NIC 24 is an interface such as a wired LAN card or a wireless LAN card, and communicates with other devices (for example, the user terminal 2 and the storage system 30) via the network 3.

The CPU 21 executes various processes according to programs stored in the memory 22 and/or the storage device 23.

The memory 22 is an example of a storage unit such as a random access memory (RAM), and stores the programs executed by the CPU 21 and necessary information.

In the present embodiment, the memory 22 stores programs and information required to construct the storage system management tool 11. The storage system management tool 11 will be described later.

The storage device 23 is an example of a storage unit, such as a hard disk or flash memory, and stores programs executed by the CPU 21, data used by the CPU 21, and data used by the user for processing.

Note that, in the example of FIG. 2, the storage system management tool 11 is illustrated as being implemented inside the storage system 10, but the storage system management tool 11 may also be implemented in a physical machine or virtual machine other than the storage system 10.

The storage system 30 is a cloud-type storage system such as a public cloud or a private cloud, for example, and includes a plurality of SDS nodes 40.

The SDS node 40 includes a CPU 41 as an example of a processor, a memory 42, a storage device 43, and an NIC 44.

The NIC 44 is an interface such as a wired LAN card or a wireless LAN card, for example, and communicates with other devices (for example, the user terminal 2, storage system 10, SDS node 40, etc.) via the network 3 or an internal network.

The CPU 41 executes various processes according to programs stored in the memory 42 and/or the storage device 43.

The memory 42 is an example of a storage unit, and is a RAM, for example, and stores the programs executed by the CPU 41 and necessary information.

In the present embodiment, the memory 42 stores programs and information required to construct the storage system management tool 31. The storage system management tool 31 stores the device configuration information 32 of the SDS node 40 in the storage system 30. When executed by the CPU 41, the storage system management tool 31 transmits the information of the device configuration information 32 to the storage system management tool 11.

The storage device 43 is an example of a storage unit, such as a hard disk or flash memory, and stores programs executed by the CPU 41, data used by the CPU 41, and data used by the user for processing.

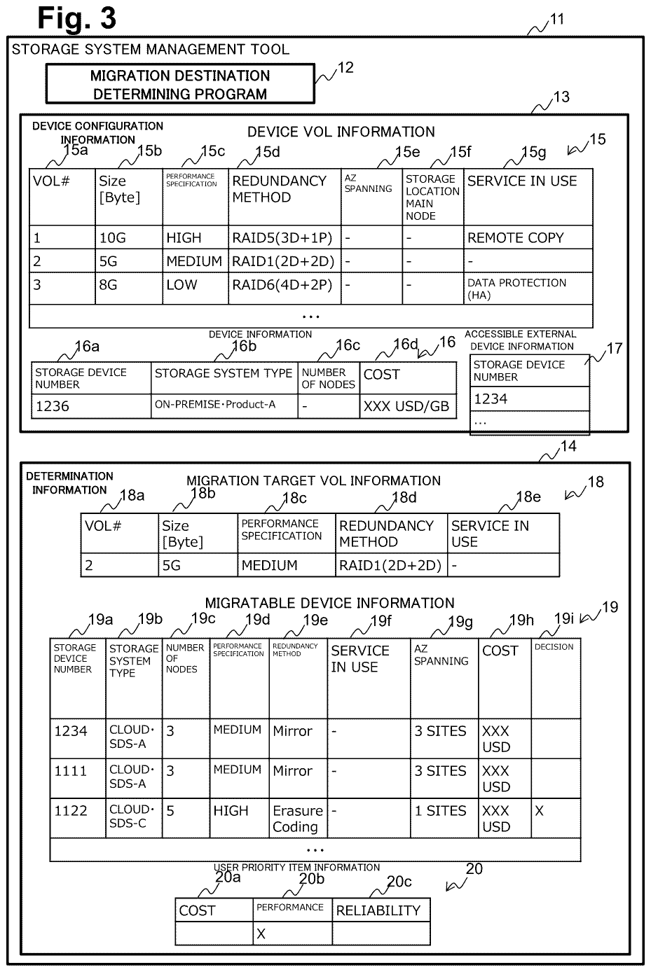

FIG. 3 is a configuration diagram of a storage system management tool according to the embodiment.

The storage system management tool 11 includes the migration destination determining program 12, the device configuration information 13, and the determination information 14.

The migration destination determining program 12 performs processing such as determination of a migration destination storage system appropriate for the migration target volume by being executed by the CPU 21. The processing will be described in detail later.

The device configuration information 13 is various types of information of the storage system 10 managed by the storage system management tool 11, and includes device VOL information 15, device information 16, and accessible external device information 17. Note that the device configuration information 32 managed by the storage system 30 has a similar configuration to the device configuration information 13, and stores information regarding the storage system 30 managed by the storage system management tool 31.

The device VOL information 15 manages information regarding volumes (VOLs) managed by the storage system 10. The device VOL information 15 stores an entry for each VOL. An entry of the device VOL information 15 includes fields for VOL number (#) 15a, size 15b, performance specification 15c, redundancy method 15d, AZ spanning 15e, storage location main node 15f, and service in use 15g.

The VOL number for identifying the VOL corresponding to the entry is stored in the VOL #15a. The size of the VOL corresponding to the entry is stored in the size 15b. Information on the specification of performance (performance specification) assigned to the VOL corresponding to the entry is stored in the performance specification 15c. The performance specification information is information indicating the performance specification based on the type of storage system and the specifications of the drives of the storage system, for example, and may be a classification such as high, medium, or low indicating the level of the performance specification, for example. The performance specification information may be decided and set according to the determination of the user at the timing of creating a VOL, for example.

The redundancy method 15d stores the redundancy method for the VOL corresponding to the entry. The redundancy method may be information indicating the RAID level and its configuration, such as RAID (3D+1P). The AZ spanning 15e stores information indicating whether the VOL corresponding to the entry is stored across a plurality of AZs. In the present embodiment, in the AZ spanning 15e, in a case in which the VOL spans a plurality of AZs, the number of AZs that the VOL spans is stored, and in a case in which the VOL does not span the plurality of AZs, for example, in a case of on-premise in the present embodiment, null is stored.

In the storage location main node 15f, when the storage system includes a plurality of nodes, information indicating the node that is the main node in accessing the VOL corresponding to the entry is stored. The service in use 15g stores the name of the service being provided by the storage system for the VOL corresponding to the entry. Here, the services include remote copy for the VOL corresponding to the entry and data protection for the VOL (for example, high availability (HA)).

The device information 16 stores information regarding the storage system 10. The device information 16 includes fields for storage device number 16a, storage system type 16b, number of nodes 16c, and cost 16d. The storage device number 16a stores the device number of the storage system 10. The storage system type 16b stores the type and the device name of the storage system 10. Types of storage systems include on-premise, private cloud, public cloud, and the like. The number of nodes 16c stores the number of nodes that make up the storage system 10. The cost per unit capacity of the storage system 10 is stored in the cost 16d.

The accessible external device information 17 stores the identification number of an external device (storage system) to which data can be transferred.

The determination information 14 contains migration target VOL information 18, migratable device information 19, and user priority item information 20.

The migration target VOL information 18 stores an entry for the VOL to be migrated (migration target VOL). Here, when the migration target VOL is the copy source of the remote copy, the VOL at copy destination of the remote copy also becomes the migration target VOL, so that an entry for the VOL at the copy destination is also stored.

An entry of the migration target VOL information 18 includes fields for VOL number (#) 18a, size 18b, performance specification 18c, redundancy method 18d, and service in use 18e.

The VOL #18a stores the VOL number that identifies the migration target VOL corresponding to the entry. The size 18b stores the size of the migration target VOL corresponding to the entry. The performance specification 18c stores information on the performance specification assigned to the migration target VOL corresponding to the entry. The redundancy method 18d stores the redundancy method for the migration target VOL corresponding to the entry. The service in use 18e stores the name of the service being provided by the storage system for the migration target VOL corresponding to the entry.

The information stored in each of the VOL number (#) 18a, size 18b, performance specification 18c, redundancy method 18d, and service in use 18e is acquired from the entry of the migration target VOL in the device VOL information 15.

The migratable device information 19 manages information regarding other storage systems (migratable devices) to which VOLs of the storage system 10 can be migrated. The migratable device information 19 stores an entry for each migratable storage system.

An entry of the migratable device information 19 includes fields for storage device number 19a, storage system type 19b, number of nodes 19c, performance specification 19d, redundancy method 19e, service in use 19f, AZ spanning 19g, cost 19h, and decision 19i.

The storage device number 19a stores the device number of the storage system corresponding to the entry. The storage system type 19b stores the type and the device name of the storage system corresponding to the entry. The number of nodes 19c stores the number of nodes in the storage system corresponding to the entry. The performance specification 19d stores the performance specification of the storage system corresponding to the entry. The redundancy method 19e stores the redundancy method for the VOL of the storage system corresponding to the entry. The service in use 19f stores the service in use in the VOL of the storage system corresponding to the entry.

The AZ spanning 19g stores the number of spanned AZs when the VOL spans AZs in the storage system corresponding to the entry, and stores null when the VOL does not span a plurality of AZs. The cost 19h stores the cost of migrating the migration target VOL to the storage system corresponding to the entry. This cost is calculated by multiplying the size of the migration target VOL by the cost per unit capacity in the storage system. The decision 19i stores a flag indicating whether or not the storage system corresponding to the entry has been decided as the migration destination of the migration target volume. Further, in a case where the migration target VOL is a VOL for which remote copying is being performed, a flag indicating the decision is set in the entry of each storage system that is the migration destination of each of the VOL at the copy source and the VOL at the copy destination.

The information stored in each of the storage device number 19a, the storage system type 19b, the number of nodes 19c, the performance specification 19d, the redundancy method 19e, the services in use 19f, and the AZ spanning 19g is obtained and set from the device configuration information 32 of other storage systems 30.

The user priority item information 20 is information indicating items that are given priority at the time of determining a migration destination storage system. The user priority item information 20 includes fields for cost 20a, performance 20b, and reliability 20c, and a flag is set in the field of the item to be prioritized. The flag in the user priority item information 20 is set according to user's designation.

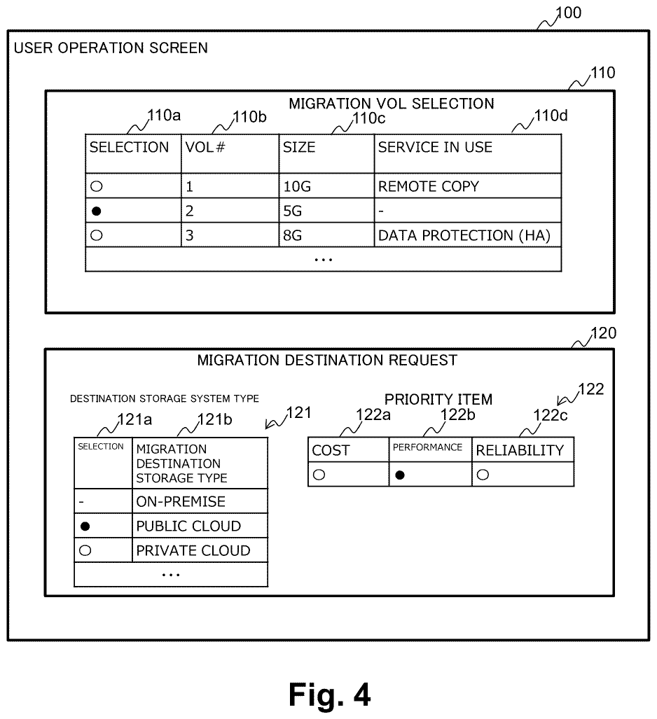

FIG. 4 is a diagram illustrating a user operation screen according to the embodiment.

A user operation screen 100 is displayed on the user terminal 2 on the basis of data sent from the storage system management tool 11. The user operation screen 100 includes a migration VOL selection area 110 and a migration destination request selection area 120.

In the migration VOL selection area 110, a row is displayed for each VOL that is a candidate for migration. A row in the migration VOL selection area 110 includes fields for selection 110a, VOL #110b, size 110c, and service in use 110d.

In the selection 110a, a button for selecting the VOL corresponding to the row as the migration target is displayed. Further, in the migration VOL selection area 110, it may be possible to select only the button for the selection 110a in the row of one VOL, or to select a plurality of buttons for the selection 110a in the rows of a plurality of VOLs. The VOL #110b displays the VOL number of the VOL corresponding to the row. The size 110c displays the size of the VOL corresponding to the row. The service in use 110d displays the service being used by the VOL corresponding to the row.

The migration destination request selection area 120 includes a destination storage system type selection area 121 and a priority item selection area 122.

The destination storage system type selection area 121 displays rows of a plurality of storage system types. The rows of the destination storage system type selection area 121 include fields for selection 121a and migration destination storage type 121b. The selection 121a displays a button for selecting the type corresponding to the row as the type of migration destination storage system. The destination storage type 121b displays the name of the type of storage system corresponding to the row. In the present embodiment, the types of storage systems include on-premise, private cloud, and public cloud, for example. Further, the selectable types may be limited to only types different from the migration source storage system, or may include the same type.

The priority item selection area 122 displays rows for selecting a prioritized item from among a plurality of items. The rows of the priority item selection area 122 include fields for cost 122a, performance 122b, and reliability 122c. The cost 122a displays a selection button for selecting cost as the item to which priority is given, the performance 122b displays a selection button for selecting performance as the item to which priority is given, and the reliability 122c displays a selection button for selecting reliability as the item to which priority is given. In the present embodiment, only one item can be selected in rows of the priority item selection area 122. It should be noted that the items to be prioritized are not limited to cost, performance, and reliability, and may include other items.

Next, the processing operation in the computer system 1 will be described.

First, the VOL migration process will be described.

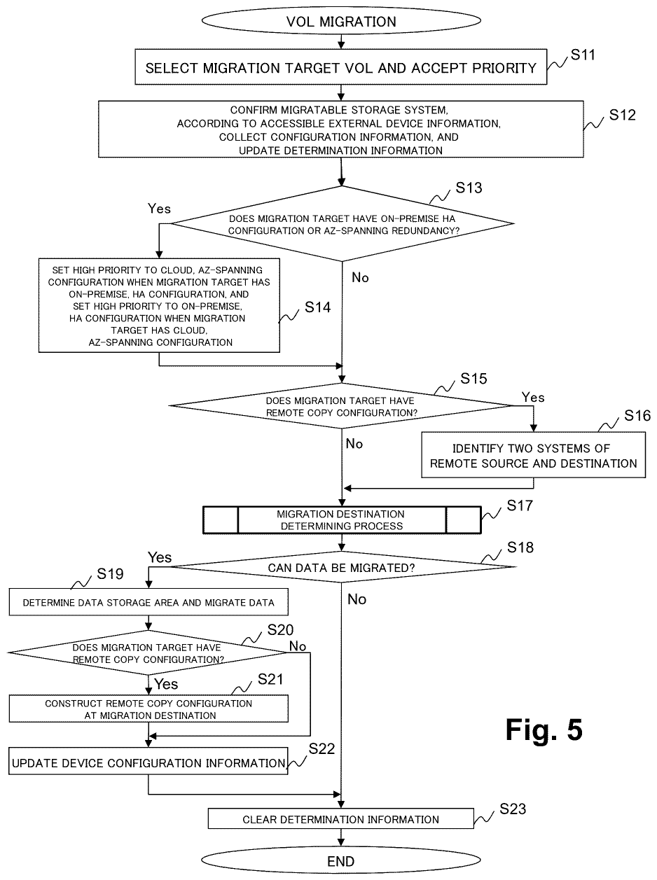

FIG. 5 is a flowchart of a VOL migration process according to the embodiment.

The migration destination determining program 12 (more precisely, the CPU 21 executing the migration destination determining program 12) displays the user operation screen 100 on the user terminal 2, and accepts the user's selection of the migration target VOL and a request for the migration destination storage system (in the present embodiment, designation of the type of storage system of the migration destination and designation of priority items) (S11). It should be noted that the priority item does not have to be designated.

Next, the migration destination determining program 12 refers to the accessible external device information 17, identifies an accessible storage system (a migratable storage system), collects configuration information from the migratable storage system, and updates the determination information 14 (S12).

Next, the migration destination determining program 12 determines whether the configuration of the migration source storage system in which the migration target VOL is stored is an on-premise HA configuration, or a cloud AZ-spanning configuration (S13).

As a result, when the configuration of the migration source storage system is an on-premise and HA configuration (S13: Yes), the migration destination determining program 12 sets high priority to a cloud storage system having an AZ-spanning configuration as the migration destination, and when the migration source storage system is a cloud storage system having an AZ-spanning configuration (S13: No), the migration destination determining program 12 sets high priority to an on-premise and HA configuration storage system as the migration destination (S14), and then proceeds to step S15. According to the processing of S14, in subsequent processing, when the configuration of the migration source storage system is on-premise and an HA configuration, a cloud storage system with an AZ-spanning configuration is selected or likely to be selected as the destination, and when the migration source storage system is a cloud storage system with an AZ-spanning configuration, an on-premise storage system with an HA configuration is selected or likely to be selected as the destination.

In contrast, when the configuration of the migration source storage system is not an on-premise HA configuration, and is also not a cloud AZ-spanning configuration (S13: No), the migration destination determining program 12 advances the process to step S15.

In step S15, the migration destination determining program 12 determines whether the migration target VOL has a remote copy configuration.

As a result, when the migration target VOL has a remote copy configuration (S15: Yes), the migration destination determining program 12 determines not only the migration target VOL but also the VOL at the remote copy destination of the migration target VOL (an example of copy destination data) as the migration target VOL, obtains configuration information of the storage system that stores the VOL at the copy destination, updates the determination information 14 (S16), and advances the process to step S17.

In contrast, when the migration target VOL does not have a remote copy configuration (S15: No), the migration destination determining program 12 advances the process to step S17.

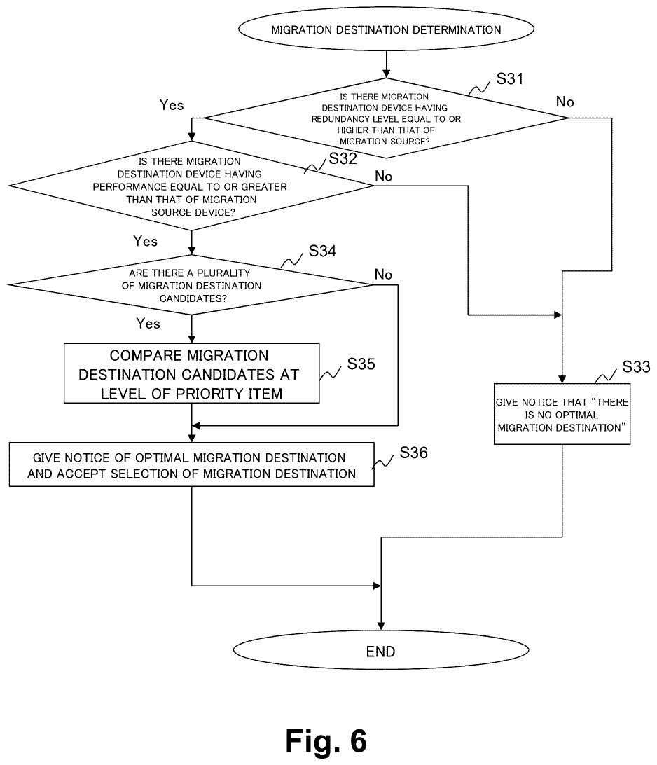

In step S17, the migration destination determining program 12 executes the migration destination determining process (see FIG. 6) for determining the migration destination for each migration target VOL.

Next, the migration destination determining program 12 determines whether or not data migration of the migration target VOL is possible as a result of the migration destination determining process, that is, whether a migration destination to which the migration target VOL is to be migrated has been decided by the migration destination determining process (S18).

As a result, when it is determined that data migration of the migration target VOL is possible (S18: Yes), the migration destination determining program 12 determines the area in the destination storage system to which the migration target VOL is to be migrated, and executes data migration of the migration target VOL (S19).

Next, the migration destination determining program 12 determines whether or not the migration target VOL has a remote copy configuration (S20). As a result, when the migration target VOL has a remote copy configuration (S20: Yes), the migration destination determining program 12 constructs a configuration such that the migration target VOL has a remote copy configuration at the migration destination, in other words, sets the relationship between the migration destination VOL (migrated data) of the VOL at the copy source in the migration target VOL and the migration destination VOL of the VOL at the copy destination to a remote copy configuration (S21), and advances the process to step S22. In contrast, when the migration target does not have a remote copy configuration (S20: No), the migration destination determining program 12 advances the process to step S22.

In step S22, the migration destination determining program 12 updates the device configuration information of the migration destination and migration source storage systems to the state after migration, and advances the process to step S23.

In contrast, when it is determined that data migration of the migration target VOL is not possible (S18: No), the migration destination determining program 12 advances the process to step S23.

In step S23, the migration destination determining program 12 clears the determination information 14 and ends the VOL migration process.

Next, the migration destination determining process in step S17 will be described.

FIG. 6 is a flowchart of a migration destination determining process according to the embodiment.

The migration destination determining program 12 determines whether or not there is a migration destination device (migration destination storage system) with a redundancy level equal to or higher than that of the migration target VOL (S31). Here, data redundancy means combining a plurality of physical disks to create one virtual disk and storing data therein, and the data is stored in a distributed manner across the physical disks. The redundancy level is determined on the basis of the degree of data distribution, the presence or absence of parity for restoring data, etc., for example, and as the ability to restore data is higher, the redundancy level becomes higher. For example, RAID6 (4D+2P) which distributes data across four disks and has parity has a higher level of redundancy than mirror which distributes the same data across two disks. Further, in the case of erasure coding, although it depends on the method supported by the storage system, basically, the number of disks in which data is distributed to be stored can be set as the redundancy level. In the present embodiment, the on-premise HA configuration and the cloud AZ-spanning configuration are treated as having the same redundancy level.

Further, when the migration target VOL is currently using the services of a storage system, whether there is a migration destination device may be determined, on the condition that the storage system is using an equivalent service of the storage system.

As a result, when it is determined that there is a destination device with a redundancy level equal to or higher than that of the migration target VOL (S31: Yes), the migration destination determining program 12 determines whether there is a destination device with performance equal to or greater than that of the source device (S32). As a result, when it is determined that there is a destination device whose performance is equal to or greater than that of the source device (S32: Yes), the migration destination determining program 12 advances the process to step S34.

When it is determined in step S31 that there is no destination device with a redundancy level equal to or higher than that of the migration target VOL (S31: No), or when it is determined in step S32 that there is no destination device with performance equal to or greater than that of the source device (S32: No), the migration destination determining program 12 notifies the user terminal 2 that there is no optimal migration destination and displays the notification thereon (S33), terminating the migration destination determining process. Note that, in step S33, the migration destination determining program 12 may give notice of and display the reason for the determination, or may give notice of and display the device configuration recommended as the migration destination storage system.

In step S34, the migration destination determining program 12 determines whether or not there are a plurality of candidates for the migration destination device (migration destination device candidates). As a result, when there are a plurality of migration destination device candidates (S34: Yes), the migration destination determining program 12 compares the migration destination device candidates regarding the priority items designated by the user, and determines the optimal destination device (S35), advancing the process to step S36. For example, when the priority item is reliability and when the storage system has a configuration spanning AZs, it is assumed that the reliability is higher as the number of spanning AZs is greater.

In contrast, when it is determined that there are not a plurality of migration destination device candidates (S34: No), the migration destination determining program 12 advances the process to step S36.

In step S36, the migration destination determining program 12 notifies the user terminal 2 of the optimum migration destination device, causes it to be displayed, accepts a selection (designation) of the migration destination device from the user, and ends the migration destination determining process.

As described above, according to the computer system 1, a device with a redundancy level equal to or higher than that of the migration target VOL can easily and appropriately be determined as the migration destination device.

It is to be noted that the present invention is not limited to the above-described embodiment, and can be modified as appropriate without departing from the spirit of the present invention.

For example, in the above embodiment, when there are a plurality of migration destination device candidates, the destination storage system is determined according to the user's priority item, but the present invention is not limited to this, and a plurality of storage systems that are migration destination device candidates may be presented, and the destination storage system may be determined according to the user's instructions.

What is claimed is:

1. A data migration support device that supports migration of migration target data in a computer system including a plurality of storage systems, the device comprising:
a storage unit; and
a processor, wherein
the storage unit stores configuration information including a type and a redundancy method of each of the plurality of storage systems, and
the processor
receives designation of information that can identify a redundancy level of the migration target data and a type of a migration destination storage system, and
determines a storage system to which the migration target data is to be migrated, on a basis of the redundancy level of the migration target data and the type.

2. The data migration support device according to claim 1, wherein
the processor receives designation of a priority item to be prioritized when determining a storage system, and,
when there are a plurality of storage systems of the designated type, each of which has a redundancy method with a redundancy level equal to or higher than a redundancy level of the migration target data, the processor determines the storage system to which the migration target data is to be migrated, on the basis of the designated priority item.

3. The data migration support device according to claim 2, wherein
the priority item is one of cost, performance, and reliability of the storage system.

4. The data migration support device according to claim 1, wherein
the type of the migration destination storage system is different from a type of a storage system in which the migration target data is stored.

5. The data migration support device according to claim 1, wherein,
when the type of the migration destination storage system is a cloud type and a storage system in which the migration target data is stored is on-premise and has a high availability configuration, the data migration support device determines a storage system whose type is a cloud type and which has a redundancy method spanning a plurality of availability zones as the storage system to which the migration target data is to be migrated.

6. The data migration support device according to claim 1, wherein,
when the type of the destination storage system is an on-premise type, and the storage system in which the migration target data is stored is a cloud storage system that uses a redundancy method spanning a plurality of availability zones, the data migration support device determines a storage system that is on-premise and has a high availability configuration as the storage system to which the migration target data is to be migrated.

7. The data migration support device according to claim 1, wherein
the migration target data is data that is to be subjected to a remote copy, and
the processor determines a storage system to which copy destination data is to be migrated, on a basis of a redundancy level of the copy destination data at a destination of the remote copy of the migration target data and the type.

8. The data migration support device according to claim 1, wherein,
when there is no appropriate storage system to which the migration target data is to be migrated, on a basis of the redundancy level of the migration target data and the type, the processor displays information regarding the recommended configuration for the migration destination storage system.

9. The data migration support device according to claim 1, wherein,
when there are a plurality of storage systems suitable for migrating the migration target data, on a basis of the redundancy level of the migration target data and the type, the processor displays information regarding the plurality of storage systems.

10. The data migration support device according to claim 1, wherein
the processor migrates the migration target data to the determined storage system.

11. The data migration support device according to claim 7, wherein
the processor migrates the migration target data to the determined storage system, and performs remote copy setting for the migrated data after migration.

12. A method for supporting data migration by using a data migration support device that supports migration of migration target data in a computer system including a plurality of storage systems, wherein
the data migration support device
stores configuration information including a type and a redundancy method of each of the plurality of storage systems,
receives designation of the migration target data and a type of a migration destination storage system, and
determines a storage system to which the migration target data is to be migrated, on a basis of a redundancy level of the migration target data and the type.
